(19) United States
(12) Patent Application Publication
(10) Pub. No.: US 2026/0198581 A1
(43) Pub. Date: Jul. 16, 2026

(54) HEATING ASSEMBLY, ATOMIZATION CORE, AND ELECTRONIC CIGARETTE

(71) Applicant: SHANDONG SINOCERA FUNCTIONAL MATERIAL CO., LTD., Shandong (CN)

(72) Inventors: Haitao WU, Shandong (CN); Guanliang SUN, Shandong (CN); Bin YANG, Shandong (CN); Hong YING, Shandong (CN); Xiaolei SUI, Shandong (CN); Binbin ZHU, Shandong (CN); Xiaolei GAO, Shandong (CN); Qingbo FU, Shandong (CN); Yong LI, Shandong (CN)

(21) Appl. No.: 19/135,977

(22) PCT Filed: Apr. 16, 2024
(86) PCT No.: PCT/CN2024/087974

§ 371 Date: Jun. 5, 2025

(30) Foreign Application Priority Data
Jul. 27, 2023 (CN) 202310931684.6
Jul. 27, 2023 (CN) 202321999977.X

(51) Int. Cl. A24F 40/46; H05B 3/02

(52) U.S. Cl. CPC A24F 40/46; H05B 3/02

(57) ABSTRACT

A heating assembly, an atomization core, and an electronic cigarette. The heating assembly is arranged on the atomization core, and comprises a first contact, a second contact, and a first resistor, wherein the first resistor is fixedly arranged between the first contact and the second contact, and at least one closed heating area is arranged on the first resistor.

### CROSS-REFERENCE TO RELATED APPLICATION

The present disclosure claims priority to Chinese patent application No. 2023109316846, filed with the Chinese Patent Office on Jul. 27, 2023, entitled “HEATING ASSEMBLY, ATOMIZATION CORE, AND ELECTRONIC CIGARETTE”; and, priority to Chinese patent application No. 202321999977X, filed with the Chinese Patent Office on Jul. 27, 2023, entitled “HEATING ASSEMBLY, ATOMIZATION CORE, AND ELECTRONIC CIGARETTE”, the entire contents of which are incorporated by reference in the present disclosure.

### TECHNICAL FIELD

The present disclosure relates to the technical field of electronic cigarettes, and in particular to a heating assembly, an atomization core, and an electronic cigarette.

### BACKGROUND ART

The atomization core is a key component of the electronic cigarette. Regarding the appearance structure of the atomization core, it can be divided into two parts: an adsorption body capable of adsorbing smoke oil and a heating circuit capable of generating heat when powered on. The interface between the adsorption body and the heating circuit is an atomizing surface. The main role of the adsorption body is to adsorb and conduct the smoke oil. The heating circuit has a certain resistance value, and its main function is to generate heat when powered on under the action of the external power source, so as to provide heat to atomize the smoke oil near the atomizing surface.

In the prior art, the shape of the heating circuit is mainly composed of a combination of a single-line continuous curve and a straight line, wherein two contacts are on two ends, and continuous heating wires in various curved shapes are arranged between the two contacts. The heating wire has a certain resistance value and will generate heat by itself when powered on. However, this type of heating body initially exhibits locally excessive temperature, and then the temperature expands to other blank regions, resulting in a relatively slow formation of a uniform and stable atomization region, which leads to low atomization efficiency and is not conducive to improving taste.

### SUMMARY

The objective of the present disclosure is to provide a heating assembly, an atomization core, and an electronic cigarette, so as to solve the problem in the prior art that the existing heating has a too high local temperature first, which results in a slower formation of relatively uniform and stable atomization region so that the atomization efficiency is low, which is not conducive to the improvement of taste.

In order to solve the above technical problems, the present disclosure provides the following technical solutions.

The present disclosure provides a heating assembly arranged on an atomization core, which includes a first contact, a second contact, and a first resistor.

The first resistor is fixedly arranged between the first contact and the second contact, and at least one closed heating area is arranged on the first resistor.

As an optional technical solution, the edge lines of the closed heating area are arranged with smooth transitions.

As an optional technical solution, the first resistor includes at least one reinforcing member, wherein the reinforcing member is fixedly arranged in the closed heating area and fixedly connected to the edge lines of the closed heating area.

As an optional technical solution, the first resistor member is arranged symmetrically about an axis of the first resistor member.

As an optional technical solution, the first resistor is provided with a closed heating area.

As an optional technical solution, the shape of the closed heating area is a circle, an ellipse, or a combination of a semi-ellipse and a semi-circle.

As an optional technical solution, the heating assembly includes two second resistors, and the first resistor is provided in the shape of a flat plate, wherein one end of the first resistor is connected to the first contact via one of the second resistors, and the other end of the first resistor is connected to the second contact via the other second resistor.

As an optional technical solution, the second resistor includes at least one connecting part, wherein the connecting part is provided in the form of a strip, and the connecting part includes at least one curved segment.

As an optional technical solution, the second resistor includes one connecting part, or the second resistor includes two connecting parts.

As an optional technical solution, the connecting part is connected to both the first resistor and the corresponding contacts in a smooth transition.

As an optional technical solution, the two second resistors are symmetrically arranged about the axis of the first resistor.

As an optional technical solution, the two second resistors are symmetrically arranged about the axis of the first resistor in an axial symmetry method.

As an optional technical solution, the two second resistors are symmetrically arranged about a center of the axis of the first resistor in an axial symmetry method.

The atomization core provided by the present disclosure includes an atomization core body and the heating assembly, and the heating assembly is arranged on the atomization core body.

The electronic cigarette provided by the present disclosure includes the atomization core.

Compared to the prior art, the heating assembly, atomization core, and electronic cigarette provided by the present disclosure have the following technical advantages.

In the first aspect, the present disclosure provides the heating assembly arranged on the atomization core, which includes the first contact, the second contact, and the first resistor, wherein the first resistor is fixedly arranged between the first contact and the second contact, and at least one closed heating area is arranged on the first resistor. The first resistor is fixedly arranged between the first contact and the second contact and is connected with both the first contact and the second contact. When the first contact is connected to the positive electrode of the power source and the second contact is connected to the negative electrode of the power source, the current passes through the first resistor and generates heat at the first resistor. Since the first resistor is provided with a closed heating area, when the heating assembly is powered on, the closed heating area generates heat, and the heat radiates to the surrounding area with the closed heating area as the center, so that a relatively stable high-temperature field is formed inside the closed heating area and within a small area outside, thereby accelerating the speed of heat accumulation in the closed heating area. Further, since the closed heating area is arranged between the first contact and the second contact, the heat loss by the first contact and the second contact can be reduced, so as to further improve the speed of heat accumulation within the closed heating area, thereby improving the atomization efficiency and the taste after the atomization.

In the second aspect, the atomization core provided by the present disclosure includes the atomization core body and the heating assembly, and the heating assembly is arranged on the atomization core body. The heating assembly is arranged on the atomizing surface of the atomization core body. When the heating assembly is powered on, a relatively stable high-temperature field is formed inside the closed heating area and within a small area outside, which improves the speed of heat accumulation within the closed heating area, thereby improving the atomization efficiency and the taste after the atomization. Moreover, due to the relatively regular shape of the closed heating area, the uniformity of the temperature distribution within the high-temperature field can be improved, thereby reducing the probability of occurrence of a burnt core or deterioration of the taste caused by excessively high local temperature.

In order to make the above objectives, features, and advantages of the present disclosure more obvious and easier to understand, the following is a detailed description of preferred embodiments in conjunction with the drawings.

### BRIEF DESCRIPTION OF DRAWINGS

In order to more clearly illustrate the technical solutions in the embodiments of the present disclosure or in the relevant art, the drawings to be used in the description of the embodiments or relevant art will be briefly introduced below. It is obvious that the drawings in the following description are some embodiments of the present disclosure. For a person of ordinary skill in the art, other drawings can be obtained based on these drawings without inventive efforts.

FIG. 1 is a structure schematic diagram of a heating assembly provided by the embodiments of the present disclosure;

FIG. 2 is another structure schematic diagram of a heating assembly provided by the embodiments of the present disclosure;

FIG. 3 is another structure schematic diagram of a heating assembly provided by the embodiments of the present disclosure;

FIG. 4 is another structure schematic diagram of a heating assembly provided by the embodiments of the present disclosure; and

FIG. 5 is another structure schematic diagram of a heating assembly provided by the embodiments of the present disclosure.

Reference numbers: 100—first contact; 200—second contact; 300—first resistor; 310—reinforcing member; and 400—connecting part.

### DETAILED DESCRIPTION OF EMBODIMENTS

The technical solutions in the embodiments of the present disclosure will be clearly and completely described below in conjunction with the drawings in the embodiments of the present disclosure. It is obvious that the embodiments described are partial embodiments of the present disclosure, and not all of the embodiments. Based on the embodiments in the present disclosure, all other embodiments obtained by a person of ordinary skill in the art without inventive efforts shall fall within the scope of protection of the present disclosure.

It should be noted that similar symbols and letters denote similar items in the following drawings. Therefore, once an item has been defined in one of the drawings, it does not need to be further defined and explained in subsequent drawings.

In the description of the present disclosure, it is to be noted that orientation or positional relationships indicated by terms, such as “center”, “up”, “down”, “left”, “right”, “vertical”, “horizontal”, “inside”, and “outside” are the orientation or positional relationships based on the drawings. These terms are only used to facilitate the description of the present disclosure and simplify the description, and are not to indicate or imply that the device or element referred to must have a particular orientation or be constructed and operated with a particular orientation. These terms are not to be understood as limitations of the present disclosure. Additionally, the terms “first”, “second”, and “third”, etc., are used only for descriptions and are not to be understood as indicating or implying relative importance. The physical quantities in the formula, if not separately marked, should be understood as the base quantities of the base units in the International System of Units, or the derived quantities derived from the base quantities through mathematical operations such as multiplication, division, differentiation, or integration.

Additionally, the terms “horizontal”, “vertical”, “overhanging”, etc., do not mean that the component must be absolutely horizontal or overhanging, but can be slightly inclined. For example, “horizontal” only refers that it is more horizontal than “vertical” and does not mean that the structure must be absolutely horizontal but can be slightly inclined.

In the description of the present disclosure, it should be noted that unless other expressly specifications and limitations, the terms “mount”, “connect”, and “link” can be understood in a broad sense. For example, it can be a fixed connection, a detachable connection, or an integral connection; it can be a mechanical connection or an electrical connection; and it can be a direct connection, an indirect connection through an intermediate medium, or an internal communication between two components. For a person of ordinary skill in the art, the specific meaning of the above terms in the present disclosure can be understood according to specific situations.

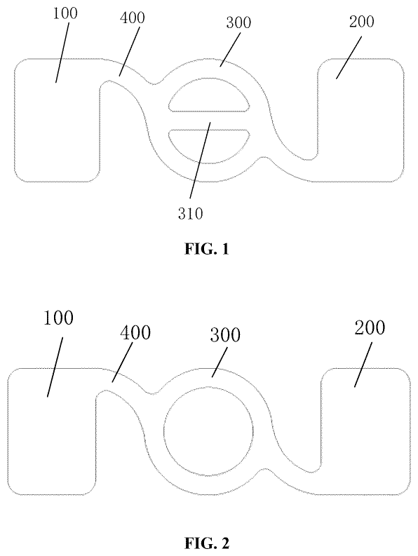

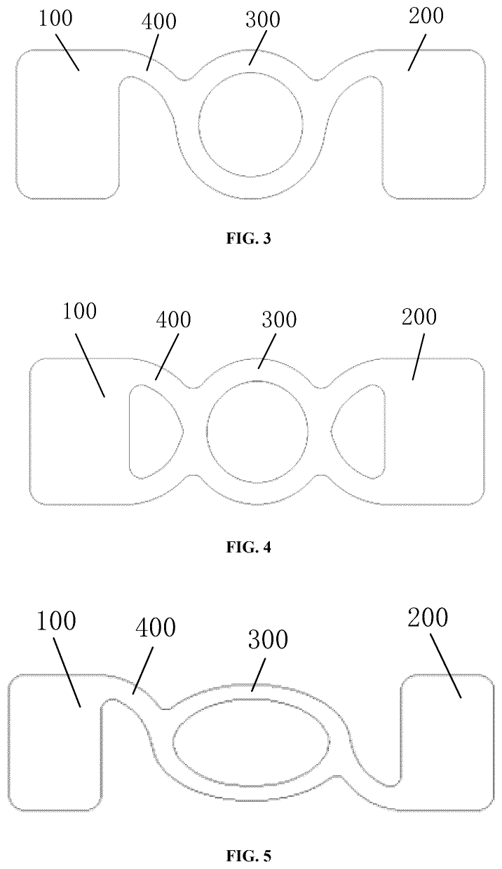

In the embodiments, there are five different embodiments of the heating assembly shown in FIG. 1 to FIG. 5 as follows.

Some embodiments of the present disclosure will be described in detail below in conjunction with the drawings. The following embodiments and features in the embodiments may be combined with each other without conflict.

The embodiments of the present disclosure provide a heating assembly arranged on the atomization core, including a first contact 100, a second contact 200, and a first resistor 300.

The first resistor 300 is fixedly arranged between the first contact 100 and the second contact 200, and at least one closed heating area is arranged on the first resistor 300.

Specifically, in conjunction with FIG. 1 to FIG. 5, the number of closed heating areas can be appropriately increased or decreased according to the actual situation, and the shape of the closed heating area can also be arranged according to the specific situation, as long as it realizes the technical effect of improving the speed of heat accumulation through the arrangement of the closed heating area.

In the embodiment, the heating assembly is entirely arranged in the shape of a flat plate, and one closed heating area is arranged. Specifically, the first resistor 300 is fixedly arranged between the first contact 100 and the second contact 200 and is connected with both the first contact 100 and the second contact 200. When the first contact 100 is connected to the positive electrode of the power source and the second contact 200 is connected to the negative electrode of the power source, the current passes through the first resistor 300 and generates heat at the first resistor 300. Since the first resistor 300 is provided with a closed heating area, when the heating assembly is powered on, the closed heating area generates heat, and the heat radiates to the surrounding area with the closed heating area as the center, so that a relatively stable high-temperature field is formed in the area of the closed heating area and within a small area outside, thereby accelerating the speed of heat accumulation in the closed heating area. Further, since the closed heating area is arranged between the first contact 100 and the second contact 200, the heat loss by the first contact 100 and the second contact 200 can be reduced, so as to further improve the speed of heat accumulation within the closed heating area, thereby improving the atomization efficiency and the taste after the atomization.

In an optional technical solution of the embodiments, edge lines of the closed heating area are arranged with smooth transitions.

Specifically, in conjunction with FIG. 1 to FIG. 5, the shape of the closed heating area can be arranged as a circle; as shown in FIG. 1 to FIG. 4, it can also be arranged as an ellipse; or as shown in FIG. 5, it is arranged as a combination of half-ellipse and half-circle. The specific arranging method is selected according to specific requirements, which only needs to realize the technical effect of improving the uniformity of temperature distribution within the high-temperature field by the structural characteristic of the closed heating area itself.

In an optional technical solution of the embodiment, the first resistor 300 includes at least one reinforcing member 310, wherein the reinforcing member 310 is fixedly arranged in the closed heating area and fixedly connected to the edge lines of the closed heating area.

Specifically, in conjunction with FIG. 1, the number of the reinforcing member 310 can be appropriately increased or decreased according to the actual situation. In the embodiment, one reinforcing member 310 is provided, and two ends of the reinforcing member 310 are connected to two opposite edge lines of the closed heating area respectively. By this arrangement, on the one hand, the resistor distribution range within the closed heating area is enlarged by the reinforcing member 310 so that a certain amount of heat can also be generated inside the closed heating area, thereby generating more heat within a certain duration; this further improves the speed of heat accumulation within the closed heating area. On the other hand, the entire strength of the first resistor 300 is improved by the reinforcing member 310, thereby further prolonging the service life of the first resistor 300 and the heating assembly.

In an optional technical solution of the embodiment, the first resistor member 300 is arranged symmetrically about an axis of the first resistor member 300.

Specifically, in conjunction with FIG. 1 to FIG. 5, this arrangement further improves the speed of heat accumulation within the closed heating area and the uniformity of temperature distribution within the high-temperature field by improving the regularity of the first resistor 300. Therefore, this improves the atomization efficiency and the taste after the atomization, and reduces the occurrence of a burnt core or deterioration of the taste caused by excessively high local temperature.

In an optional technical solution of the embodiment, the heating assembly includes two second resistors, and the first resistor 300 is provided in the shape of a flat plate, wherein one end of the first resistor 300 is connected to the first contact 100 via one of the second resistors, and the other end of the first resistor 300 is connected to the second contact 200 via the other second resistor.

Specifically, in conjunction with FIG. 1 to FIG. 5, this arrangement avoids the direct contact among the first resistor 300, the first contact 100, and the second contact 200 by providing the two second resistors, which further reduces the amount of heat loss when passing through the first contact 100 and the second contact 200. This improves the speed of heat accumulation within the closed heating area, thereby improving the atomization efficiency and the taste after the atomization.

In an optional technical solution of the embodiment, the second resistor includes at least one connecting part 400, wherein the connecting part 400 is provided in the form of a strip, and the connecting part 400 includes at least one curved segment.

Specifically, in conjunction with FIG. 1 to FIG. 5, the second resistor can include one connecting part 400, as shown in FIG. 1 to FIG. 3 and FIG. 5; or it can include two connecting parts 400, as shown in FIG. 4. Both two arrangement methods can improve the speed of heat accumulation within the closed heating area and the uniformity of temperature distribution within the high-temperature field, and therefore, the atomization efficiency and the taste after the atomization can be improved, and the probability of the situation of a burnt core or deterioration of the taste due to the local temperature being too high is reduced.

Additionally, when the second resistor includes two connecting parts 400, three closed heating areas are provided between the first contacts 100 and the second contacts 200, thereby further improving the speed of heat accumulation within the closed heating area. Since the second resistor includes two connecting parts 400, when one of the connecting parts 400 is damaged, the other connecting part 400 can continue to be powered on, which ensures the effect in use of the heating assembly and prolongs the service life of the heating assembly.

In an optional technical solution of the embodiment, the connecting part 400 is connected to both the first resistor 300 and the corresponding contacts in a smooth transition.

Specifically, in conjunction with FIG. 1 to FIG. 5, this arrangement avoids the obvious inflection point on the connecting part 400, which may result in the concentration of heat at the inflection point. This further improves the uniformity of the temperature distribution within the high-temperature field.

In an optional technical solution of the embodiment, the two second resistors are symmetrically arranged about the axis of the first resistor 300.

Specifically, in conjunction with FIG. 1 to FIG. 5, the two second resistors can symmetrically about the axis of the first resistor member 300 in an axial symmetry method, or can be arranged symmetrically about the center of the axis of the first resistor member 300 in an axial symmetry method. This arrangement improves the overall regularity of the heating assembly, and further improves the uniformity of the temperature distribution within the high-temperature field. Therefore, the atomization efficiency and the taste after the atomization is improved, and the probability of occurrence of a burnt core or deterioration of the taste caused by excessively high local temperature is reduced.

The atomization core provided by the embodiment includes the atomization core body and the heating assembly, and the heating assembly is arranged on the atomization core body.

Specifically, in conjunction with FIG. 1 to FIG. 5, the heating assembly is arranged on the atomizing surface of the atomization core body. When the heating assembly is powered on, a relatively stable high-temperature field is formed inside the closed heating area and within a small area outside, which improves the speed of heat accumulation within the closed heating area, thereby improving the atomization efficiency and the taste after the atomization. Moreover, due to the relatively regular the shape of the closed heating area, it can improve the uniformity of the temperature distribution within the high-temperature field, thereby reducing the probability of occurrence of a burnt core or deterioration of the taste caused by excessively high local temperature.

The electronic cigarette provided by the embodiment includes the atomization core. Since the electronic cigarette contains all the structures of the atomization core, the electronic cigarette provided in the embodiment contains all the beneficial effects of the atomization core described above.

Finally, it should be noted that the above embodiments are only used to illustrate the technical solutions of the present disclosure and are not to restrict the technical solutions of the present disclosure. Although the present disclosure is described in detail with reference to each foregoing embodiments, it should be understood by persons of ordinary skill in the art that they can still modify the technical solutions described in the foregoing embodiments or make equivalent substitutions for some or all of the technical features, and these modifications or substitutions do not take the essence of the corresponding technical solutions out of the scope of the technical solutions in each embodiment of the present disclosure.

### INDUSTRIAL APPLICABILITY

The present disclosure provides a heating assembly, an atomization core, and an electronic cigarette so that a relatively stable high-temperature field is formed inside the closed heating area and within a small area outside, thereby accelerating the speed of heat accumulation in the closed heating area. Since the closed heating area is arranged between the first contact and the second contact, which reduces the loss of the heat passing through the first contact and the second contact, so as to further improve the speed of heat accumulation within the closed heating area and improve the atomization efficiency and the taste after the atomization.

1. A heating assembly, arranged on an atomization core, comprising: a first contact, a second contact, and a first resistor, wherein
the first resistor is fixedly arranged between the first contact and the second contact, and at least one closed heating area is arranged on the first resistor.

2. The heating assembly according to claim 1, wherein edge lines of the closed heating area are arranged with smooth transitions.

3. The heating assembly according to claim 1, wherein the first resistor comprises at least one reinforcing member, and the reinforcing member is fixedly arranged in the closed heating area and fixedly connected to the edge lines of the closed heating area.

4. The heating assembly according to claim 1, wherein the first resistor member is arranged symmetrically about an axis of the first resistor member.

5. The heating assembly according to claim 1, wherein the first resistor is provided with one closed heating area.

6. The heating assembly according to claim 1, wherein a shape of the closed heating area is provided as a circle, an ellipse, or a combination of a semi-ellipse and a semi-circle.

7. The heating assembly according to claim 1, wherein the heating assembly comprises two second resistors; the first resistor is provided in a shape of a flat plate, wherein one end of the first resistor is connected to the first contact via one of the second resistors, and another end of the first resistor is connected to the second contact via another second resistor.

8. The heating assembly according to claim 7, wherein the second resistor comprises at least one connecting part, the connecting part is provided in a form of a strip, and the connecting part comprises at least one curved segment.

9. The heating assembly according to claim 8, wherein the second resistor comprises one connecting part or the second resistor comprises two connecting parts.

10. The heating assembly according to claim 8, wherein the connecting part is connected to the first resistor and corresponding contacts in a smooth transition.

11. The heating assembly according to claim 10, wherein two second resistors are symmetrically arranged about the axis of the first resistor.

12. The heating assembly according to claim 11, wherein two second resistors are symmetrically arranged about the axis of the first resistor in an axial symmetry method.

13. The heating assembly according to claim 11, wherein two second resistors are symmetrically arranged about a center of the axis of the first resistor in an axial symmetry method.

14. An atomization core, comprising an atomization core body and the heating assembly according to claim 1, wherein the heating assembly is arranged on the atomization core body.

15. An electronic cigarette, comprising the atomization core according to claim 14.

16. The heating assembly according to claim 2, wherein the first resistor comprises at least one reinforcing member, and the reinforcing member is fixedly arranged in the closed heating area and fixedly connected to the edge lines of the closed heating area.

17. The heating assembly according to claim 2, wherein the first resistor member is arranged symmetrically about an axis of the first resistor member.

18. The heating assembly according to claim 2, wherein the first resistor is provided with one closed heating area.

19. The heating assembly according to claim 2, wherein a shape of the closed heating area is provided as a circle, an ellipse, or a combination of a semi-ellipse and a semi-circle.

20. The heating assembly according to claim 2, wherein the heating assembly comprises two second resistors; the first resistor is provided in a shape of a flat plate, wherein one end of the first resistor is connected to the first contact via one of the second resistors, and another end of the first resistor is connected to the second contact via another second resistor.
